(19) United States
(12) Patent Application Publication
(10) Pub. No.: US 2016/0162906 A1
(43) Pub. Date: Jun. 9, 2016

(54) TECHNOLOGY CHANGE STANDARDS COMPLIANCE SYSTEM

(71) Applicant: BANK OF AMERICA CORPORATION, CHARLOTTE, NC (US)

(72) Inventors: Melinda A. Irby, Charlotte, NC (US); Rajat Wadhwani, Closter, NJ (US); Bridget E. O'Connor, Holmdel, NJ (US); Susan McClung, Charlotte, NC (US); Kailash Poddar, Coppell, TX (US); Timothy Charles Murray, Charlotte, NC (US); Timothy Guerry, Cornelius, NC (US); Ananthakrishnan Ravi Venkataraman, Irving, TX (US)

(21) Appl. No.: 14/561,767

(22) Filed: Dec. 5, 2014

(51) Int. Cl. G06Q 30/00

(52) U.S. Cl. CPC G06Q 30/018

(57) ABSTRACT

Disclosed is a system for evaluating standards compliance for technology changes. The system typically includes a processor, a memory, and a permit module stored in the memory. The technology change standards compliance system is typically configured for: determining design compliance to produce a design compliance determination indicating an extent to which a design status of a technology change complies with at least one of the one or more design compliance rules; determining whether to permit building of the technology change based at least on the design compliance determination; determining building compliance to produce a building compliance determination indicating an extent to which a build status of the technology change complies with at least one of the one or more building compliance rules; and determining whether to permit operation of the technology change based at least on the building compliance determination.

### FIELD OF THE INVENTION

The present invention embraces a technology change standards compliance system. The system typically includes a processor and a memory. The system also typically includes a permit module stored in the memory, which is typically configured for (i) determining whether to permit building of a technology change and (ii) determining whether to permit operation of the technology change.

### BACKGROUND

Organizations often implement various types of technology changes. Accordingly, a need exists for an improved way of ensuring that an organization's requirements for a technology change have been met.

### SUMMARY

In one aspect, the present invention embraces a technology change standards compliance system and a corresponding method and computer program product. The technology change standards compliance system typically includes a processor and a memory. The technology change standards compliance system also typically includes a permit module stored in the memory and executable by the processor.

In one embodiment, the permit module is configured for: receiving design standards information comprising one or more design compliance rules for technology changes; storing the design standards information; determining a design status of a first technology change according to design information received regarding the first technology change; determining design compliance to produce a design compliance determination indicating an extent to which the design status complies with at least one of the one or more design compliance rules; determining whether to permit building of the first technology change based at least on the design compliance determination; generating, in response to determining to permit building of the first technology change, a build permit notification, the build permit notification indicating that building of the first technology change is permitted; communicating the build permit notification to a user, receiving building standards information, the building standards information comprising one or more building compliance rules for technology changes; storing the building standards information; determining a building status of the first technology change according to building information received regarding the first technology change; determining building compliance to produce a building compliance determination indicating an extent to which the information indicating the building status of the first technology change complies with at least one of the one or more building compliance rules; determining whether to permit operation of the first technology change based at least on the building compliance determination; generating, in response to determining to permit operation of the first technology change, an operate permit notification, the operate permit notification indicating that operating of the first technology change is permitted; and communicating the operate permit notification to the user.

In a particular embodiment, the permit module is configured for: generating, in response to determining that building of the first technology change is not permitted, a first request notification, the first request notification indicating that additional design information is needed before building of the first technology change is permitted; and communicating the first request notification to the user. The permit module may be further configured for: generating, in response to determining that operation of the first technology change is not permitted, a second request notification, the second request notification indicating that additional building information is needed before operation of the first technology change is permitted; and communicating the second request notification to the user.

In another particular embodiment, the permit module is configured for: identifying, after the operation of the first technology change is permitted, an error associated with the operation of the technology change; and associating the error with at least one of a design compliance rule and a building compliance rule.

In yet another particular embodiment, the design compliance rules comprise applicability rules defining the kinds of technology changes to which the design compliance rules are applicable; determining design compliance comprises determining which of the design compliance rules are applicable to the first technology change; the building compliance rules comprise applicability rules defining the kinds of technology changes to which the building compliance rules are applicable; and determining building compliance comprises determining which of the building compliance rules are applicable to the first technology change.

In yet another particular embodiment, each design compliance rule comprises a rule type, the rule type indicating an impact of the design compliance determination associated with each design compliance rule on the determination of whether to permit building of the technology change.

In yet another particular embodiment, the design compliance rules comprise one or more rules related to design quality, information security compliance; data and records management, business continuity, and vendor management; and the building compliance rules comprise one or more rules related to deployment manageability; operational manageability; testing; information security compliance; data and records management, business continuity, and vendor management.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 depicts a system for facilitating technology change standards compliance in accordance with an exemplary embodiment of the present invention;

FIG. 2 depicts a technology change standards compliance sequence in accordance with an exemplary embodiment of the present invention; and

FIG. 3 depicts a graphical user interface which facilitates interaction with the system for facilitating technology change standards compliance in accordance with an exemplary embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asset management firms, insurance companies and the like. In specific embodiments of the invention, use of the term “bank” is limited to a financial entity in which account-bearing customers conduct financial transactions, such as account deposits, withdrawals, transfers and the like.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that engage in risk assessment and management.

A “user” may be any person or entity using a technology change standards compliance system described herein. Often, a user is an employee of an entity (e.g., a financial institution) using a technology change standards compliance system. In some instances a user has a management position within an entity using a technology change standards compliance system.

As used herein, the term “technology change” refers to any technology development and/or deployment project. Such technology projects include projects in which technology is designed or implemented from scratch, “update” projects that involve modifying and/or adding to existing technology, or any other type of technology development and/or deployment project. The technology involved in a technology change may include software and/or hardware. Technology changes may include a design phase in which plans for the technology change are developed. The design process may include preparation of various design documents, such as specifications, goals, technology architecture documents, or any other suitable type of design document. Technology changes may also include a build phase in which previously developed plans are implemented. This process may include procuring, configuring, and otherwise setting up hardware components; writing code, configuration files, or other aspects of software; and testing the hardware and/or software. The separation of design and build phases does not require that they are mutually exclusively. For example, the design of a technology change may be modified during the building phase.

In one aspect, the present invention embraces a technology change standards compliance system that may be used by an entity, such as a financial institution, to determine whether a technology change complies with various entity standards. In particular, if certain entity standards have been met, a permit to build the technology change may be issued by the system. Subsequently, once certain other entity standards have been met, a permit to operate the technology change may be issued by the system.

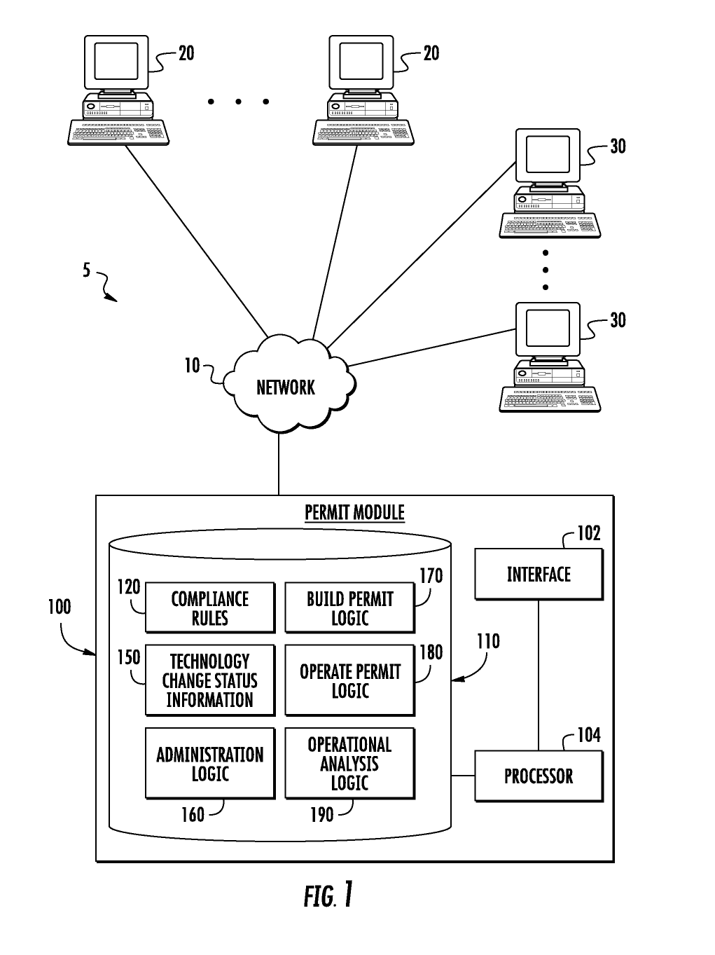

In this regard, FIG. 1 illustrates an example system 5 that facilitates technology change standards compliance for an entity. System 5 includes permit module 100, which communicates with one or more endpoints 20 and one or more workstations 30 over network 10. Permit module 100 includes processor 104, which is communicatively coupled to network interface 102, and memory 110. Memory 110 includes compliance rules 120, technology change status information 150, administration logic 160, build permit logic 170, operate permit logic 180, and operational analysis logic 190, which facilitate standards compliance during technology development and deployment.

Permit module 100 facilitates compliance with one or more standards during the design, implementation, and use of a technology change. One or more compliance rules 120, which may include design compliance rules and build compliance rules, are communicated from endpoint 20 to permit module 100 over network 10 and stored in memory 110. Permit module 100 then evaluates the status of the technology change's design and then determines the extent to which the design status complies with the design compliance rules. Based on the design compliance determination, permit module 100 determines whether to issue a build permit for the technology change, allowing building of the technology change to begin. Issuing build permits for technology changes in this manner may allow for more effective enforcement of design standards during the technology development process. Issuing build permits for technology changes in this manner may also provide a more efficient and cost-effective mechanism for ensuring that certain standards are met before implementation of the technology change can begin.

Once the build permit issues and implementation of the technology change begins, permit module 100 evaluates the status of the building of the technology change and determines the extent to which the build status complies with the build compliance rules. Based on this build compliance determination, permit module 100 determines whether to issue an operate permit for the technology change, allowing operation of the technology change to begin. Issuing operate permits for technology changes in this manner may allow for more effective enforcement of build standards during the technology development and deployment process, which may improve the quality of technology changes. Issuing operate permits for technology changes in this manner may also provide a more efficient and cost-effective mechanism for ensuring that certain standards are met before technology changes are put into operation.

According to the illustrated embodiment, system 5 includes endpoints 20 that communicate with permit module 100 through network 10. Endpoints 20 may include one or more laptops, personal computers, monitors, display devices, handheld devices, smartphones, servers, user input devices, or any other suitable component for enabling the communication of standards information. Endpoints 20 communicate standards information to permit module 100. For example, a personal computer may be used to submit standards information to permit module 100 through network 10, enabling permit module 100 to enforce compliance with these standards during the designing, building, and operating of a technology change. This standards information may be design standards information, which includes one or more design compliance rules, and/or build standards information, which includes one or more build compliance rules.

Design compliance rules describe requirements or recommendations for the design and/or operation of a technology change. For example, design compliance rules may describe requirements or recommendations relating to strategic alignment, which may include business strategy alignment, technology strategy alignment, and/or infrastructure strategy alignment; information security compliance; data and records management, which may include data quality rules, cross border data movement policies, data and records retention policies, defining or identifying data provisioning points, and/or data feeds controls and requirements; design quality, which may include resiliency, performance, scalability, complexity, and/or capacity management; compliance with assistive technology guidelines (i.e., guidelines to ensure that technology can be used by persons with disabilities); resource readiness, which may include human resources and documentation; testing, which may include testing strategy, comprehensiveness, and code management; operational manageability, which may include system and operational documentation as well as control and warranty phase plans; deployment manageability; business continuity and/or disaster recovery policies, including determining the impact to recovery plans and recovery objectives; vendor management policies, including vendor strategies, due diligence, risk assessment, and/or vendor registration; and/or monitoring, which may include monitoring comprehensiveness or design.

Build compliance rules describe requirements or recommendations for the building and/or operation of a technology change. For example, build compliance rules may describe requirements or recommendations relating to design quality; compliance with assistive technology guidelines (i.e., guidelines to ensure that technology can be used by persons with disabilities); change policies, including change registration, assessment, authorization, and notification; monitoring; testing; system and operational documentation; deployment manageability; operational manageability; capacity management; information security compliance; data and records management, which may include data quality rules, data controls measurement and reporting, cross border data movement policies, data and records retention policies, registering data provisioning points, creating data sharing agreements, and/or data feeds controls and requirements; business continuity and/or disaster recovery policies, including updating recovery plans and recovery objectives; vendor management policies, including performing vendor management routines, assessing vendor quality and performance, and determining if proprietary data can be sent to vendor; people readiness; or control and warranty phase plans. One or more of the build compliance rules may be related to, similar to, or identical to one or more of the design compliance rules.

Some design compliance rules and build compliance rules may be applicable to all technology changes being implemented by the entity. Other design compliance rules and build compliance rules may be applicable to only certain technology changes. For example, certain compliance rules may only apply to technology changes being implemented by certain organizations (e.g., business units, departments, lines of business, and the like) within the entity. In addition, certain compliance rules may only apply to certain types of technology changes. For example, certain compliance rules may only apply to software changes, and other certain compliance rules may only apply to hardware changes. Additionally, information security policies may only apply to technology changes that have an information security impact, data management policies may only apply to technology changes having data management impacts, cross border data movement policies may only apply to technology changes where is data will be moved across jurisdictional borders, and vendor management policies may only apply to technology changes provided at least in part by a vendor. Accordingly, at least some of the compliance rules may include applicability rules defining the kinds of technology changes to which the compliance rules are applicable. For example, a compliance rule may include an applicability rule that such compliance rule only applies to software changes. Alternatively, users may indicate that one or more compliance rules apply to a particular technology change.

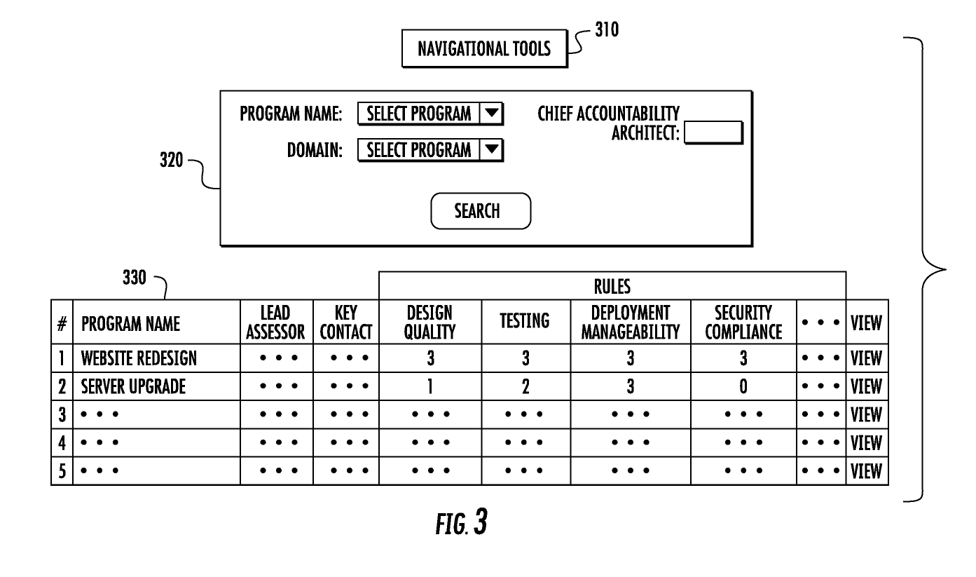

Workstations 30 enable one or more users to monitor, administer, or otherwise interact with permit module 100. Workstations 30 may include one or more laptops, personal computers, monitors, display devices, handheld devices, smartphones, servers, user input devices, or other suitable components for enabling user input. During operation of permit module 100, a workstation 30 enables a user to monitor the status of a technology change. For example, workstation 30 allows a user to monitor whether a technology change has received a build permit or an operate permit. Workstation 30 also enables monitoring design compliance associated with a technology change, as discussed below in reference to FIG. 3. In some embodiments, workstation 30 may also allow users to monitor errors or other problems associated with a technology change. For example, a user could monitor the status of a technology change that has received an operate permit and is currently in use in order to facilitate the association of an operational error with an underlying compliance rule or one or more individuals responsible for that aspect of the technology change. Enabling such associations may allow users to identify shortcomings in the underlying compliance rules, which may facilitate the improvement of these standards, or provide a more effective and efficient accountability mechanism. In some embodiments, workstation 30 and endpoint 20 may be integrated or may be the same device.

Network 10 represents any suitable network operable to facilitate communication between the components of system 5. Network 10 may include any interconnecting system capable of transmitting audio, video, signals, data, messages, or any combination of the preceding. Network 10 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof operable to facilitate communication between the components.

Permit module 100 represents any suitable components that facilitate software development standards compliance in system 5. Permit module 100 may include a network server, remote server, mainframe, host computer, workstation, web server, personal computer, file server, or any other suitable device operable to communicate with endpoints 20 and process data. In some embodiments, permit module 100 may execute any suitable operating system. The functions of permit module 100 may be performed by any suitable combination of one or more servers or other components at one or more locations. In the embodiment where the modules are servers, the servers may be public or private servers, and each server may be a virtual or physical server. The server may include one or more servers at the same or at remote locations. Permit module 100 may also include any suitable component that functions as a server. In some embodiments, endpoint 20 and/or workstation 30 may be integrated with permit module 100, or they may operate as part of the same device or devices.

In the illustrated embodiment, permit module 100 includes network interface 102, processor 104, and memory 110.

Network interface 102 represents any suitable device operable to receive information from network 10, transmit information through network 10, perform suitable processing of the information, communicate to other devices, or any combination thereof. For example, network interface 102 receives from endpoints 20 design standards information and build standards information. As another example, network interface 102 communicates information regarding a technology change's compliance to workstations 30 to facilitate monitoring and administration of standards compliance. Network interface 102 represents any port or connection, real or virtual, including any suitable hardware and/or software, including protocol conversion and data processing capabilities, to communicate through a LAN, WAN, or other communication system that allows permit module 100 to exchange information with network 10, endpoints 20, workstations 30, other permit modules 100, or other components of system 5.

Processor 104 communicatively couples to network interface 102 and memory 110, and controls the operation and administration of permit module 100 by processing information received from network interface 102 and memory 110. Processor 104 includes any hardware and/or software that operates to control and process information. For example, processor 104 executes build permit logic 170 to control the determination of whether to permit building of technology changes and executes operate permit logic 180 to control the determination of whether to permit operating of technology changes. Processor 104 may be a programmable logic device, a microcontroller, a microprocessor, any suitable processing device, or any suitable combination of the preceding.

Memory 110 stores, either permanently or temporarily, data, operational software, or other information for processor 104, other components of permit module 100, or other components of system 5. Memory 110 includes any one or a combination of volatile or nonvolatile local or remote devices suitable for storing information. For example, memory 110 may include random access memory (RAM), read only memory (ROM), flash memory, magnetic storage devices, optical storage devices, network storage devices, cloud storage devices, solid state devices, or any other suitable information storage device or a combination of these devices. While illustrated as including particular modules, memory 110 may include any suitable information for use in the operation of permit module 100. In the illustrated embodiment, memory 110 includes compliance rules 120, technology change status information 150, administration logic 160, build permit logic 170, operate permit logic 180, and operational analysis logic 190.

Compliance rules 120 represent any suitable information operable to facilitate the determination of whether a technology change is in compliance with one or more standards. Compliance rules 120 also represent any suitable set of instructions, logic, or code embodied in a computer-readable storage medium and operable to facilitate the determination of whether a technology change is in compliance with one or more standards. Permit module 100 may evaluate status information associated with the technology change against one or more compliance rules 120 to determine whether to issue a build permit or an operation permit. Compliance rules 120 may include design compliance rules or build compliance rules.

Design compliance rules describe requirements or recommendations for the design and/or operation of a technology change. For example, design compliance rules may describe requirements or recommendations relating to strategic alignment, which may include business strategy alignment, technology strategy alignment, and/or infrastructure strategy alignment; information security compliance; data and records management, which may include data quality rules, cross border data movement policies, data and records retention policies, defining or identifying data provisioning points, and/or data feeds controls and requirements; design quality, which may include resiliency, performance, scalability, complexity, and/or capacity management; compliance with assistive technology guidelines (i.e., guidelines to ensure that technology can be used by persons with disabilities); resource readiness, which may include human resources and documentation; testing, which may include testing strategy, comprehensiveness, and code management; operational manageability, which may include system and operational documentation as well as control and warranty phase plans; deployment manageability; business continuity and/or disaster recovery policies, including determining the impact to recovery plans and recovery objectives; vendor management policies, including vendor strategies, due diligence, risk assessment, and/or vendor registration; and/or monitoring, which may include monitoring comprehensiveness or design.

Build compliance rules describe requirements or recommendations for the building and/or operation of a technology change. For example, build compliance rules may describe requirements or recommendations relating to design quality; compliance with assistive technology guidelines (i.e., guidelines to ensure that technology can be used by persons with disabilities); change policies, including change registration, assessment, authorization, and notification; monitoring; testing; system and operational documentation; deployment manageability; operational manageability; capacity management; information security compliance; data and records management, which may include data quality rules, data controls measurement and reporting, cross border data movement policies, data and records retention policies, registering data provisioning points, creating data sharing agreements, and/or data feeds controls and requirements; business continuity and/or disaster recovery policies, including updating recovery plans and recovery objectives; vendor management policies, including performing vendor management routines, assessing vendor quality and performance, and determining if proprietary data can be sent to vendor; people readiness; or control and warranty phase plans. One or more of the build compliance rules may be related to, similar to, or identical to one or more of the design compliance rules. Application of compliance rules 120 during the design, building, and operation of a technology change may increase the efficiency of the software development process and improve the speed-to-market, stability, and overall quality of the technology change. Application of compliance rules 120 may also improve end-to-end program governance and accountability by providing a framework for associating design, build, or operational errors with particular rules and/or particular individuals or organizations.

Technology change status information 150 may include design status information, build status information, or operation status information of a technology change. Design status information may indicate the completeness or quality of various aspects of the design (e.g., documentation, designer communications, testing plans, or security design compliance), various errors or problems associated with the design (e.g., missing documents or resources, design flaws, or design deadlines), or any other information indicating the status of the technology change's design. Design status information may be used to determine design compliance that enable permit module 100 to determine whether to issue a build permit for the technology change. Build status information may indicate the completeness or quality of various aspects of the build (e.g., source code, operational objectives, testing results, or security compliance), various errors or problems associated with the build (e.g., compiling errors, missed build deadlines, operational shortcomings), or any other information indicating the status of the technology change's build. Build status information may be used to determine build compliance that enable permit module 100 to determine whether to issue an operate permit for the technology change. Operation status information may indicate the quality or effectiveness of various aspects of the technology change's operation (e.g., processing speed, operational objectives, security compliance, user complaints, or monitoring results), various errors or problems associated with the operation of the technology change (e.g., runtime errors, user complaints, or other operational shortcomings), or any other information indicating the status of the technology change's operation. Operation status information may enable permit module 100 to associate the technology change's operation status with one or more individuals, groups, organizations, and/or compliances rules.

Technology change status information 150 may also include information that can be used to assess the applicability of the compliance rules to a particular technology change. For example, technology change status information 150 may include information related to the type of technology change (e.g., hardware or software) involved, entity organizations associated with (e.g., implementing or overseeing) the technology change, information security information, data management information, information regarding vendors associated with the technology change, or any other information need to assess the applicability of compliance rules to a particular technology change.

Administration logic 160 represents any suitable set of instructions, logic, or code embodied in a computer-readable storage medium and operable to facilitate the administration of permit module 100. Administration logic 160 enables one or more administrators to view, add, delete, or modify one or more compliance rules, status information, associations between compliance rules and one or more entities, the extent of compliance (e.g., build and/or design compliance), build permits, or operate permits. For example, administration logic 160 may operate to present a graphical user interface (“GUI”) on a user's display (e.g., a display associated with workstation 30) with which the user can interact to perform one or more of the tasks described above. Such an example is described in greater detail below in reference to FIG. 3. In presenting a GUI, administration logic 160 may also utilize images, text, or other assets. Administration logic 160 may be stored in memory 110 or another memory associated with permit module 100. Administration logic 160, or portions thereof, may also be embodied in hardware associated with permit module 100 or other components of system 5. Furthermore, the components of administration logic 160 may be stored in the same or different memories of the same or different permit modules 100. Various components of administration logic 160 may also be stored in different components of system 5.

Build permit logic 170 represents any suitable set of instructions, logic, or code embodied in a computer-readable storage medium and operable to facilitate the issuance of a build permit for a technology change. Build permit logic 170 may be stored in memory 110 or another memory associated with permit module 100. Build permit logic 170, or portions thereof, may also be embodied in hardware associated with permit module 100 or other components of system 5. Furthermore, the components of build permit logic 170 may be stored in the same or different memories of the same or different permit modules 100. Various components of build permit logic 170 may also be stored in different components of system 5.

In operation, building permit logic 170 evaluates the design status of a technology change and determines whether to permit building of the technology change. To accomplish this, building permit logic 170 determines a design status of a technology change according to design information received regarding the technology change. The design status includes design status information, which may indicate the completeness or quality of various aspects of the technology change's design (e.g., documentation, designer communications, testing plans, or security design compliance), various errors or problems associated with the design (e.g., missing documents or resources, design flaws, or design deadlines), or any other information indicating the status of the technology change's design. This design status is used to determine the extent to which the design status of the technology change complies with one or more design compliance rules. For example, the build permit logic 170 may look for evidence or other information indicating that applicable rules have been complied with. The build permit logic 170 may also determine which design compliance rules are applicable to a technology change. In this regard, the build permit logic 170 may compare applicability rules to technology change status information to determine which design compliance rules are applicable to a technology change. In addition, the build permit logic 170 may determine if a user has indicated that a particular design compliance rule is applicable to a particular technology change (or type of technology change).

In some embodiments, one or more design compliance score reflecting the extent to which the design status of the technology change complies with one or more design compliance rules may be calculated. In a particular embodiment, compliance scores range from 0 to 3, a score of 0 indicating that the rule is not applicable to the technology change, a score of 1 indicating that the aspect of the technology change associated with the rule is either not in place or fails an evaluation due to having too many exceptions to be effective, a score of 2 indicating that the aspect of the technology change associated with the rule is in place and effective with minor gaps, and a score of 3 indicating that the aspect of the technology change associated with the rule is in place and passes the evaluation as effective. However, numerous scoring metrics are possible. For example, other embodiments may utilize a 0-10 scale, a pass-fail scale, a color-coded scale, any other scale suitable for compliance scoring, or any combination thereof.

In some embodiments, each design compliance rule has a rule type (e.g., “non-negotiable,” “critical,” or “recommended”), which indicates the impact on the build permit determination of design compliance associated with that rule. For example, a rule type of “non-negotiable” may indicate that a low design compliance score or other determined lack of compliance for that design compliance rule results in automatic denial of a build permit for the technology change, while a rule type of “recommended” may indicate that a low design compliance score or other determined lack of compliance for that design compliance rule will not automatically result in denial of a build permit (though it may result in one or more notifications related to compliance). As a particular example, a security compliance rule may have a “non-negotiable” rule type, indicating that a low compliance score or other determined lack of compliance for the security compliance rule would result in automatic denial of the build permit. Based at least in part on the determined design compliance, build permit logic 170 determines whether to permit building of the technology change. In some embodiments, build permit logic 170 also communicates a permit notification to one or more users indicating that building of the technology change is permitted or that additional information or action is needed before building of the technology change is permitted. This mechanism of evaluating and approving the design of a technology change may increase the efficiency of the technology development process and improve the speed-to-market, stability, and overall quality of the technology change since aspects of the technology changes that are important to swiftly, efficiently, and effectively developing technology may be verified before building can begin.

Operate permit logic 180 represents any suitable set of instructions, logic, or code embodied in a computer-readable storage medium and operable to facilitate the issuance of an operate permit for a technology change. Operate permit logic 180 may be stored in memory 110 or another memory associated with permit module 100. Operate permit logic 180, or portions thereof, may also be embodied in hardware associated with permit module 100 or other components of system 5. Furthermore, the components of operate permit logic 180 may be stored in the same or different memories of the same or different permit modules 100. Various components of operate permit logic 180 may also be stored in different components of system 5.

In operation, operate permit logic 180 evaluates the build status of a technology change and determines whether to permit operation of the technology change. To accomplish this, operate permit logic 180 determines a build status of a technology change according to build information received regarding the technology change. The build status includes build status information, which may indicate the completeness or quality of various aspects of the build (e.g., source code, operational objectives, testing results, or security compliance), various errors or problems associated with the build (e.g., compiling errors, missed build deadlines, operational shortcomings), or any other information indicating the status of the technology change's build. This build status is used to determine the extent to which the build status of the technology change complies with one or more build compliance rules. The operate permit logic 180 may also determine which build compliance rules are applicable to a technology change. In this regard, the operate permit logic 180 may compare applicability rules to technology change status information to determine which build compliance rules are applicable to a technology change. In addition, the operate permit logic 180 may determine if a user has indicated that a particular build compliance rule is applicable to a particular technology change (or type of technology change).

In some embodiments, each build compliance rule has a rule type (e.g., “non-negotiable,” “critical,” or “recommended”), which indicates the impact on the operate permit determination of the build compliance associated with that rule. For example, a rule type of “non-negotiable” may indicate that a low build compliance score or other determined lack of compliance for that build compliance rule results in automatic denial of an operate permit for the technology change, while a rule type of “recommended” may indicate that a low build compliance score or other determined lack of compliance for that build compliance rule will not automatically result in denial of an operate permit (though it may result in one or more notifications related to compliance). As a particular example, a build testing rule may have a “non-negotiable” rule type, indicating that a low compliance score or other determined lack of compliance for the security compliance rule would result in automatic denial of the operate permit. As another example, a people readiness rule may have a “critical” rule type, indicating that a low compliance score or other determined lack of compliance for that rule would require review and approval by a one or more individuals before an operate permit is issued, but will not automatically result in permit denial. Based at least in part on the build compliance determination, operate permit logic 180 determines whether to permit operating of the technology change. In some embodiments, operate permit logic 180 also communicates a permit notification to one or more users indicating that the technology change can be put into production or that additional information or action is needed before the technology change can be put into production. This mechanism of evaluating and approving the build of a technology change before operating the technology change may begin may allow for more effective enforcement of build standards during the technology development and deployment process. Issuing operate permits for technology changes in this manner may also provide a more efficient and cost-effective mechanism for ensuring that certain standards are met before the technology change can be put into production.

Operational analysis logic 190 represents any suitable set of instructions, logic, or code embodied in a computer-readable storage medium and operable to evaluate the operating status of the technology change and associate the operating status with one or more compliance rules. Operational analysis logic 190 may be stored in memory 110 or another memory associated with permit module 100. Operational analysis logic 190, or portions thereof, may also be embodied in hardware associated with permit module 100 or other components of system 5. Furthermore, the components of operational analysis logic 190 may be stored in the same or different memories of the same or different permit modules 100. Various components of operational analysis logic 190 may also be stored in different components of system 5.

In operation, operational analysis logic 190 evaluates the operating status of the technology change and associates the operating status with one or more compliance rules. For example, operational analysis logic 190 may identify an error associated with the operation of the technology change and associate the error with a compliance rule. As one example, operational analysis logic 190 may identify a runtime error associated with a software that was issued an operate permit. Operational analysis logic 190 may then identify a build testing compliance rule associated with the aspect of the technology change that produced the error and, optionally, communicate a notification of the error and its associated compliance rule to one or more users. As another example, operational analysis logic 190 may identify a security failure while monitoring the operation of the technology change. Operational analysis logic 190 may then identify one or more security compliance rules associated with the security failure and, optionally, communicate a notification of the security failure and its associated security compliance rule or rules to one or more users. Operational analysis logic 190 may also associate an error with one or more individuals, groups, or organizations who were responsible for that aspect of the technology change or who were responsible for evaluating the technology change against the implicated compliance rule. Identifying errors and associating them with compliance rules or one or more entities may allow for improved accountability in the technology development and deployment process since the compliance rule and/or a particular person, group, or organization that may be at least partially responsible for the error can be effectively and efficiently identified. Identifying errors and associating them with compliance rules or one or more entities may also provide improved end-to-end program governance since oversight of the technology development and deployment process can be managed through an integrated framework.

In an exemplary embodiment of operation, a user submits standards information at endpoint 20, which then communicates the standards information, including compliance rules 120, to permit module 100, which stores the standards information in memory 110. After design of a technology change begins, permit module 100 executes build permit logic 170, which facilitates determining a design status of the technology change and determining the extent to which the design status complies with the design compliance rules. Based on the determined design compliance, permit module 100 determines whether to permit building of the technology change, in which case a notification that building of the technology change has been permitted is communicated to one or more users. If building is not permitted, permit module 100 notifies one or more users that additional information or action is required before building can be permitted. After building of the technology change begins, permit module 100 executes operate permit logic 180, which facilitates determining a build status of the technology change and determining the extent to which the build status complies with the build compliance rules. Based on the determined build compliance, permit module 100 determines whether to permit operation of the technology change, in which case a notification that operating of the technology change has been permitted is communicated to one or more users. If operating is not permitted, permit module 100 notifies one or more users that additional information or action is required before operating can be permitted. In some embodiments, users of workstations 30 may monitor the status of the technology change. For example, a user of workstation 30 may communicate a request for the compliance scores (or other indication of the extent of compliance) associated with one or more technology changes. Permit module 100 may execute administration logic 160 to facilitate the communication of a response including compliance information (e.g., a score response including compliance scores) to the user. In certain embodiments, once operating of the technology change begins, permit module 100 executes operational analysis logic 190 to monitor the operational status of the technology change and associate errors that occur with one or more compliance rules and/or one or more individuals, groups, or organizations.

A component of system 5 may include an interface, logic, memory, and/or other suitable element. An interface receives input, sends output, processes the input and/or output, and/or performs other suitable operations. An interface may comprise hardware and/or software. Logic performs the operation of the component. For example, logic executes instructions to generate output from input. Logic may include hardware, software, and/or other logic. Logic may be encoded in one or more non-transitory, tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 5 without departing from the scope of the invention. For example, system 5 may implement standards compliance procedures different from or in addition to those described herein. As another example, multiple permit modules 100 may operate in parallel to facilitate standards compliance. As yet another example, compliance rules 120 may be configurable by a user of permit module 100, endpoint 20, or workstation 30, facilitating the modification of existing rules, deletion of existing rules, or insertion of additional rules. System 5 may include any number of endpoints 20, networks 10, permit modules 100, and workstations 30. Any suitable logic may perform the functions of system 5 and the components within system 5.

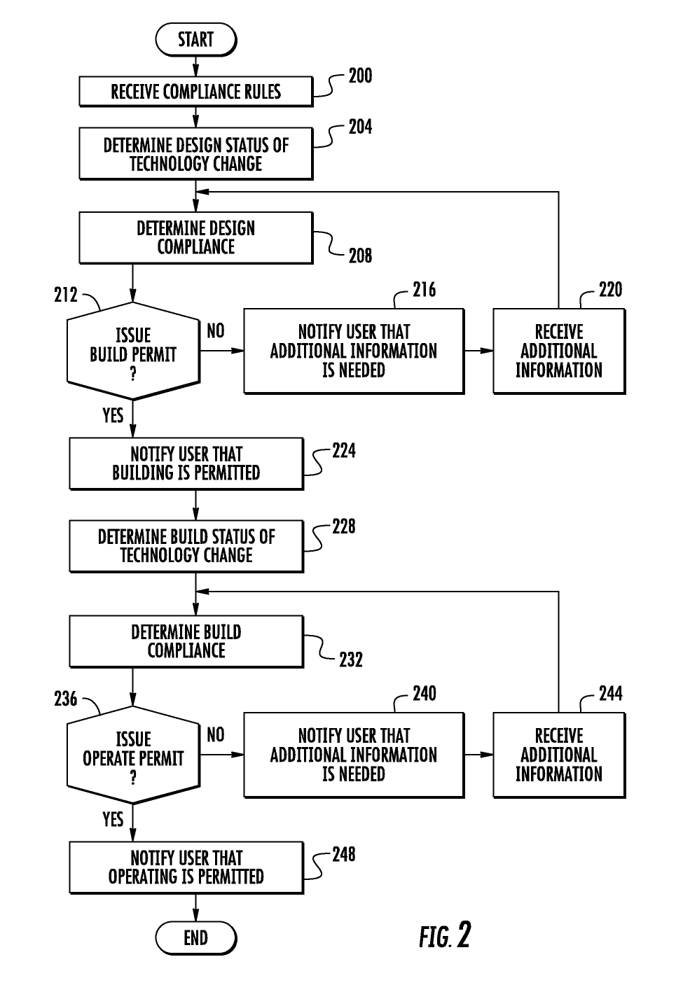

FIG. 2 is a diagram that illustrates an example technology change standards compliance sequence of permit module 100.

At step 200, permit module 100 receives compliance rules 120 from an endpoint 20. Compliance rules 120 may include design compliance rules or build compliance rules. Design compliance rules describe requirements or recommendations for the design and/or operation of a technology change. Build compliance rules describe requirements or recommendations for the building and/or operation of a technology change. One or more of the build compliance rules may be related to, similar to, identical to, or associated with one or more of the design compliance rules.

At step 204, permit module 100 determines a design status of the technology change. The design status includes design status information, which may indicate the completeness or quality of various aspects of the technology change's design (e.g., documentation, designer communications, testing plans, or security design compliance), various errors or problems associated with the design (e.g., missing documents or resources, design flaws, or design deadlines), or any other information indicating the status of the technology change's design. Permit module 100 may determine the design status by monitoring files, systems, or other aspects of the technology change's design. In some embodiments, permit module 100 may also receive input from one or more users (e.g., via a workstation 30) indicating design status information.

At step 208, permit module 100 determines the extent to which the design status of the technology change complies with one or more design compliance rules. In some embodiments, each design compliance rule has a rule type (e.g., “non-negotiable,” “critical,” or “recommended”), which indicates the impact on the build permit determination of the extent of compliance associated with that rule. For example, a rule type of “non-negotiable” may indicate that a low design compliance score (or other determined lack of compliance) for that design compliance rule results in automatic denial of a build permit for the technology change, while a rule type of “recommended” may indicate that a low design compliance score (or other determined lack of compliance) for that design compliance rule will not automatically result in denial of a build permit (though it may result in one or more notifications related to compliance). In some embodiments, the permit module 100 may determine which design compliance rules are applicable to a technology change before determining design compliance for such technology change.

At step 212, permit module 100 determines whether the determination of design compliance warrants issuance of a build permit. This determination is based at least in part on the extent of design compliance (e.g., reflected in one or more design compliance scores), and, in some embodiments, the rule type of the compliance rule(s). For example, in some instances, permit module 100 may determine that a build permit should be issued because compliance scores (or other compliance determination) indicate that all design compliance rules have been fully complied with. If permit module 100 does determine that a build permit is warranted, the sequence proceeds to step 224. However, in some cases, permit module may determine that a building permit is not warranted. This may occur if, for example, a compliance rule that has a “non-negotiable” type has a corresponding compliance score (or other compliance determination) indicating that such rule has not been complied with. In such cases, the sequence proceeds to step 216.

At step 216, permit module 100 notifies a user that additional design information is needed. This notification may involve sending an email to the user, sending a text message to the user, notifying the user via an application that runs on workstation 30 or another device, or any other suitable form of notification. The notification may identify the compliance rule or rules that resulted in denial of the build permit, provide information about the design status, request further information from the user, request further action by the user, and/or provide any information necessary to inform the user about the issue.

At step 220, permit module 100 receives additional design information following the request by permit module 100 to provide additional information. Such information may be design document updates, testing plan updates, user input overriding the denial of the build permit, or any other information regarding the design of the technology change. After the additional information has been received, permit module 100 may return to step 208 and reevaluate the extent of compliance. In some embodiments, an administrator may be able to bypass this recalculation and proceed directly to step 224.

At step 224, permit module 100 communicates a notification of a build permit for the technology change. The build permit indicates that building of the technology change can proceed. Evaluating and approving the build of a technology change in this manner may increase the efficiency of the technology development and deployment process and improve the speed-to-market, stability, and overall quality of the technology change since aspects of the technology changes that are important to swiftly, efficiently, and effectively developing technology may be verified before building can begin. Once building of the technology change commences, permit module 100 may proceed to step 228.

At step 228, permit module 100 determines a build status of the technology change. Build status may include build status information indicating the completeness or quality of various aspects of the build (e.g., source code, operational objectives, testing results, or security compliance), various errors or problems associated with the build (e.g., compiling errors, missed build deadlines, operational shortcomings), or any other information indicating the status of the technology change's build. Build status information may be used later to determine compliance that enable permit module 100 to determine whether to issue an operate permit for the technology change. Permit module 100 may determine the build status by monitoring files, systems, or other aspects of the technology change's build. In some embodiments, permit module 100 may also receive input from one or more users (e.g., via a workstation 30) indicating build status information.

At step 232, permit module 100 determines build compliance by determining the extent to which the build status of the technology change complies with one or more build compliance rules. In some embodiments, each build compliance rule has a rule type (e.g., “non-negotiable,” “critical,” or “recommended”), which indicates the impact on the build permit determination of the compliance determination associated with that rule. For example, a rule type of “non-negotiable” may indicate that a low build compliance score (or other determined lack of compliance) for that build compliance rule results in automatic denial of an operate permit for the technology change, while a rule type of “recommended” may indicate that a low build compliance score (or other determined lack of compliance) for that build compliance rule will not automatically result in denial of an operate permit (though it may result in one or more notifications related to compliance). In some embodiments, the permit module 100 may determine which build compliance rules are applicable to a technology change before determining build compliance for such technology change.

At step 236, permit module 100 determines whether the extent of build compliance warrants issuance of an operate permit. This determination is based at least in part on the extent of build compliance, and, in some embodiments, the rule type of the compliance rule(s). For example, in some instances, permit module 100 may determine that an operate permit should be issued because the compliances scores (or other indication of compliance) indicate that all build compliance rules have been fully complied with. If permit module 100 does determine that an operate permit is warranted, the sequence proceeds to step 248. However, in some cases, permit module may determine that an operate permit is not warranted. This may occur if, for example, a compliance rule that has a “non-negotiable” type has a corresponding compliance score (or other indication of the extent of compliance) indicating that the rule has not been complied with. In such cases, the sequence proceeds to step 240.

At step 240, permit module 100 notifies a user that additional build information is needed. This notification may involve sending an email to the user, sending a text message to the user, notifying the user via an application that runs on workstation 30 or another device, or any other suitable form of notification. The notification may indicate the compliance rule or rules that resulted in denial of the operate permit, provide information about the build status, request further information from the user, request further action by the user, and/or provide any information necessary to inform the user about the issue.

At step 244, permit module 100 receives additional build information following the request by permit module 100 to provide additional information. Such information may be code updates or additions, bug fixes, additional testing, user input overriding the denial of the operate permit, or any other information regarding the build of the technology change. After the additional information has been received, permit module 100 may return to step 232 and reevaluate the extent of compliance. In some embodiments, an administrator may be able to bypass this recalculation and proceed directly to step 248.

At step 248, permit module 100 communicates a notification of an operate permit for the technology change. The operate permit indicates that the technology change can be put into production. Evaluating and approving the build of a technology change in this manner may increase the efficiency of the technology development and deployment process and improve the speed-to-market, stability, and overall quality of the technology change since aspects of the technology changes that are important to providing accurate, stable technology that aligns with the goals of the entity developing and/or using it can be verified efficiently and effectively before the technology change is put into production. End-to-end governance and accountability may also be improved since downstream aspects of the technology development can be associated with earlier aspects of the development. Furthermore, this mechanism of evaluating and approving the build of a technology change before operating can begin may allow for more effective enforcement of build standards during the technology development and deployment process. Issuing operate permits for technology changes in this manner may also provide a more efficient and cost-effective mechanism for ensuring that certain standards are met before the technology change can be put into production.

Various embodiments may perform some, all, or none of the steps described above. For example, certain embodiments may omit steps 204, 218, 224, 228, 240, and/or 248 under certain conditions, or they may omit these steps entirely. Furthermore, certain embodiments may perform these steps in different orders or in parallel. While discussed as permit module 100 performing these steps, any suitable component of system 5 may perform one or more steps of the method.

FIG. 3 illustrates an example GUI 300, which facilitates administrating, monitoring, and otherwise interacting with permit module 100. GUI 300 may be presented on a display of one or more workstations 30 following execution of administration logic 160. GUIs 300 are generally operable to tailor and filter data entered by and presented to the user. GUI 300 may provide the user with an efficient and user-friendly presentation of information and may comprise a plurality of displays having interactive fields, pull-down lists, and buttons operated by the user. Different embodiments of GUI 300 may utilize common components, information, or computer code. GUIs 300 may include multiple levels of abstraction including groupings and boundaries. It should be understood that the term GUI may be used in the singular or in the plural to describe one or more GUIs 300 and each of the displays of a particular GUI 300.

GUI 300 facilitates review and input by a user related to one or more technology changes. GUI 300 includes navigational tools area 310, search area 320, and technology change information area 330.

Navigational tools area 310 facilitates navigation through various views of information related to the technology changes. For example, navigational tools area 310 may include links, tabs, buttons, or any other suitable component to enable a user to navigate to a different view.

Search area 320 facilitates searching for one or more technology changes. As shown in FIG. 3, search area 320 may include components that enable searching by program name, domain, and chief accountability architect. A program name may be the name of a technology change or group of technology changes. A domain may be an organization, grouping, characterization, or other category associated with one or more technology changes. A chief accountability architect is an individual, group, or other entity associated with a technology change and accountable for one or more compliance rules as applied to that technology change. In various embodiments, the search components may be drop-down menus, lists, hyperlinks, buttons, text boxes, or any other suitable component for facilitating searching. As one example of user interaction with search area 320, a user may interact with a “program name” drop-down menu, which then displays a list of technology changes, and the user may then select the desired entry and interact with the “search” button to search for one or more technology changes.

Technology change information area 330 facilitates user review of one or more technology changes. As illustrated in FIG. 3, technology change information area 330 includes a list of search results, including for each technology change a program name, a lead assessor, a key contact, one or more compliance rules and their corresponding determined extent of compliance, and a button that facilitates viewing additional information about the technology change. Other embodiments may include all, some, or none of this information, and they may include additional information and utilize difference layouts.

Similar GUIs 300 may also be used to facilitate other aspects of monitoring and administering one or more technology changes. Furthermore, various GUIs may have some, all, or none of the components shown in FIG. 3. Various GUIs may also have additional components. For example, some embodiments of GUI 300 may have different numbers and types of buttons in navigational tools area 310 and search area 320, may present different pieces of information in technology change information area 330, and may have different layouts of the various components. Additional GUIs may facilitate notification of permits, notification of permit rejections, and review of errors associated with technology changes. For example, a GUI may be utilized to facilitate review of errors and associated compliance rules and/or accountable entities after a technology change goes into production following the issuance of an operate permit. Furthermore, certain GUIs may provide different views and/or different information depending on which user is interacting with the GUI. For example, a software developer may be presented with a view showing only his technology change, a program manager may be presented with information related to all technology changes within his purview, and a higher level officer may be able to review all technology changes within an organization. Furthermore, different individuals or groups of individuals may have different review options. For example, a software developer may be able view the compliance scores (or other indication of the extent of compliance) for his software-related technology change, while higher level individuals may be able to both view and edit compliance scores (or other indications of the extent of compliance).

The evaluation of standards compliance by permit module 100 and subsequent presentation of GUI 300 to facilitate user review of technology changes may provide a more uniform, efficient, and reliable method of enforcing standards compliance during technology development and deployment. For example, GUIs 300 may provide a single set of interfaces for facilitating review of multiple types of technology changes. This integrated framework may provide a more cost-effective mechanism for enforcing standards compliance during technology development and deployment because multiple projects can be reviewed and evaluated through a single tool. Furthermore, the integration and association of design, build, and operating information within a single tool may also facilitate improved end-to-end governance and collaboration between different stakeholders.

Certain embodiments of the invention may provide one or more technical advantages. Certain embodiments may provide improved end-to-end governance during technology development and deployment. Certain embodiments may allow for improved communication and collaboration regarding design and build standards during the technology development and deployment. Certain embodiments may also provide improved development efficiency, shorter time-to-deployment for technology changes, and improved technology stability and flexibility. Furthermore, some embodiments may provide a more effective and efficient mechanism for ensuring that technology changes align with various design, build, and operating standards.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for evaluating standards compliance for technology changes, comprising:
a processor;
a memory;
a permit module stored in the memory, executable by the processor and configured for:
receiving design standards information comprising one or more design compliance rules for technology changes;
storing the design standards information;
determining a design status of a first technology change according to design information received regarding the first technology change;
determining design compliance to produce a design compliance determination indicating an extent to which the design status complies with at least one of the one or more design compliance rules;
determining whether to permit building of the first technology change based at least on the design compliance determination;
generating, in response to determining to permit building of the first technology change, a build permit notification, the build permit notification indicating that building of the first technology change is permitted;
communicating the build permit notification to a user,
receiving building standards information, the building standards information comprising one or more building compliance rules for technology changes;
storing the building standards information;
determining a building status of the first technology change according to building information received regarding the first technology change;
determining building compliance to produce a building compliance determination indicating an extent to which the information indicating the building status of the first technology change complies with at least one of the one or more building compliance rules;
determining whether to permit operation of the first technology change based at least on the building compliance determination;
generating, in response to determining to permit operation of the first technology change, an operate permit notification, the operate permit notification indicating that operating of the first technology change is permitted; and
communicating the operate permit notification to the user.

2. The system according to claim 1, wherein the permit module is configured for:
generating, in response to determining that building of the first technology change is not permitted, a first request notification, the first request notification indicating that additional design information is needed before building of the first technology change is permitted; and
communicating the first request notification to the user.

3. The system according to claim 2, wherein the permit module is configured for:
generating, in response to determining that operation of the first technology change is not permitted, a second request notification, the second request notification indicating that additional building information is needed before operation of the first technology change is permitted; and
communicating the second request notification to the user.

4. The system according to claim 1, wherein the permit module is configured for:
identifying, after the operation of the first technology change is permitted, an error associated with the operation of the technology change; and
associating the error with at least one of a design compliance rule and a building compliance rule.

5. The system according to claim 1, wherein:
the design compliance rules comprise applicability rules defining the kinds of technology changes to which the design compliance rules are applicable;
determining design compliance comprises determining which of the design compliance rules are applicable to the first technology change;
the building compliance rules comprise applicability rules defining the kinds of technology changes to which the building compliance rules are applicable; and
determining building compliance comprises determining which of the building compliance rules are applicable to the first technology change.

6. The system according to claim 1, wherein each design compliance rule comprises a rule type, the rule type indicating an impact of the design compliance determination associated with each design compliance rule on the determination of whether to permit building of the technology change.

7. The system according to claim 1, wherein:
the design compliance rules comprise one or more rules related to design quality, information security compliance; data and records management, business continuity, and vendor management; and
the building compliance rules comprise one or more rules related to deployment manageability; operational manageability; testing; information security compliance; data and records management, business continuity, and vendor management.

8. A computer program product for evaluating standards compliance for technology changes comprising a non-transitory computer-readable storage medium having computer-executable instructions for:
receiving design standards information comprising one or more design compliance rules for technology changes;
storing the design standards information;
determining a design status of a first technology change according to design information received regarding the first technology change;
determining design compliance to produce a design compliance determination indicating an extent to which the design status complies with at least one of the one or more design compliance rules;
determining whether to permit building of the first technology change based at least on the design compliance determination;
generating, in response to determining to permit building of the first technology change, a build permit notification, the build permit notification indicating that building of the first technology change is permitted;
communicating the build permit notification to a user,
receiving building standards information, the building standards information comprising one or more building compliance rules for technology changes;
storing the building standards information;
determining a building status of the first technology change according to building information received regarding the first technology change;
determining building compliance to produce a building compliance determination indicating an extent to which the information indicating the building status of the first technology change complies with at least one of the one or more building compliance rules;
determining whether to permit operation of the first technology change based at least on the building compliance determination;
generating, in response to determining to permit operation of the first technology change, an operate permit notification, the operate permit notification indicating that operating of the first technology change is permitted; and
communicating the operate permit notification to the user.

9. The computer program product according to claim 8, wherein the non-transitory computer-readable storage medium has computer-executable instructions for:
generating, in response to determining that building of the first technology change is not permitted, a first request notification, the first request notification indicating that additional design information is needed before building of the first technology change is permitted; and
communicating the first request notification to the user.

10. The computer program product according to claim 9, wherein the non-transitory computer-readable storage medium has computer-executable instructions for:
generating, in response to determining that operation of the first technology change is not permitted, a second request notification, the second request notification indicating that additional building information is needed before operation of the first technology change is permitted; and communicating the second request notification to the user.

11. The computer program product according to claim 8, wherein the non-transitory computer-readable storage medium has computer-executable instructions for:
identifying, after the operation of the first technology change is permitted, an error associated with the operation of the technology change; and
associating the error with at least one of a design compliance rule and a building compliance rule.

12. The computer program product according to claim 8, wherein:
the design compliance rules comprise applicability rules defining the kinds of technology changes to which the design compliance rules are applicable;
determining design compliance comprises determining which of the design compliance rules are applicable to the first technology change;
the building compliance rules comprise applicability rules defining the kinds of technology changes to which the building compliance rules are applicable; and
determining building compliance comprises determining which of the building compliance rules are applicable to the first technology change.

13. The computer program product according to claim 8, wherein each design compliance rule comprises a rule type, the rule type indicating an impact of the design compliance determination associated with each design compliance rule on the determination of whether to permit building of the technology change.

14. The computer program product according to claim 8, wherein:
the design compliance rules comprise one or more rules related to design quality, information security compliance; data and records management, business continuity, and vendor management; and
the building compliance rules comprise one or more rules related to deployment manageability; operational manageability; testing; information security compliance; data and records management, business continuity, and vendor management.

15. A method for evaluating standards compliance for technology changes comprising:
receiving, via a computer processor, design standards information comprising one or more design compliance rules for technology changes;
storing, via a computer processor, the design standards information;
determining, via a computer processor, a design status of a first technology change according to design information received regarding the first technology change;
determining, via a computer processor, design compliance to produce a design compliance determination indicating an extent to which the design status complies with at least one of the one or more design compliance rules;
determining, via a computer processor, whether to permit building of the first technology change based at least on the design compliance determination;
generating, via a computer processor, in response to determining to permit building of the first technology change, a build permit notification, the build permit notification indicating that building of the first technology change is permitted;
communicating, via a computer processor, the build permit notification to a user,
receiving, via a computer processor, building standards information, the building standards information comprising one or more building compliance rules for technology changes;
storing, via a computer processor, the building standards information;
determining, via a computer processor, a building status of the first technology change according to building information received regarding the first technology change;
determining, via a computer processor, building compliance to produce a building compliance determination indicating an extent to which the information indicating the building status of the first technology change complies with at least one of the one or more building compliance rules;
determining, via a computer processor, whether to permit operation of the first technology change based at least on the building compliance determination;
generating, via a computer processor, in response to determining to permit operation of the first technology change, an operate permit notification, the operate permit notification indicating that operating of the first technology change is permitted; and
communicating, via a computer processor, the operate permit notification to the user.

16. The method according to claim 15, comprising:
generating, in response to determining that building of the first technology change is not permitted, a first request notification, the first request notification indicating that additional design information is needed before building of the first technology change is permitted; and
communicating the first request notification to the user.

17. The method according to claim 16, comprising:
generating, in response to determining that operation of the first technology change is not permitted, a second request notification, the second request notification indicating that additional building information is needed before operation of the first technology change is permitted; and
communicating the second request notification to the user.

18. The method according to claim 15, comprising:
identifying, after the operation of the first technology change is permitted, an error associated with the operation of the technology change; and
associating the error with at least one of a design compliance rule and a building compliance rule.

19. The method according to claim 15, wherein:
the design compliance rules comprise applicability rules defining the kinds of technology changes to which the design compliance rules are applicable;
determining design compliance comprises determining which of the design compliance rules are applicable to the first technology change;
the building compliance rules comprise applicability rules defining the kinds of technology changes to which the building compliance rules are applicable; and
determining building compliance comprises determining which of the building compliance rules are applicable to the first technology change.

20. The method according to claim 15, wherein each design compliance rule comprises a rule type, the rule type indicating an impact of the design compliance determination associated with each design compliance rule on the determination of whether to permit building of the technology change.

21. The method according to claim 15, wherein:
the design compliance rules comprise one or more rules related to design quality, information security compliance; data and records management, business continuity, and vendor management; and
the building compliance rules comprise one or more rules related to deployment manageability; operational manageability; testing; information security compliance; data and records management, business continuity, and vendor management.
